(19) United States
(12) Patent Application Publication
(10) Pub. No.: US 2017/0177580 A1
(43) Pub. Date: Jun. 22, 2017

(54) TITLE STANDARDIZATION RANKING ALGORITHM

(71) Applicant: LinkedIn Corporation, Mountain View, CA (US)

(72) Inventor: Vita Markman, San Francisco, CA (US)

(21) Appl. No.: 14/975,633

(22) Filed: Dec. 18, 2015

(51) Int. Cl. G06F 17/30; G06Q 50/00; G06Q 10/06

(52) U.S. Cl. CPC G06F 17/3053; G06Q 10/063112; G06Q 50/01

(57) ABSTRACT

A method of ranking a set of candidate standardized titles selected from a corpus of standardized titles is disclosed. The set of candidate standardized titles are selected from the corpus of standardized titles as corresponding to a raw title. A combined inverse document frequency score is determined for each candidate standardized title in the set of candidate standardized titles. The combined inverse document frequency score is based on inverse frequency scores for each of a set of tokens derived from the set of candidate standardized titles. A ranking score is determined for each of the set of candidate standardized titles based on the combined inverse document frequency score. The ranking score for each of the set of candidate standardized titles is communicated for use by a separate module to improve an accuracy in a functionality of the separate module.

### TECHNICAL FIELD

The present disclosure generally relates to the technical field of data processing and, in one embodiment, to ranking a candidate set of standardized title strings with respect to a strength of their correspondences to a raw title strings.

### BACKGROUND

A social network system, such as LinkedIn®, may have various back-end applications that adapt their functionality based on information that is known about users that are accessing them. For example, a news teed application may provide a user with content items based on the user's current job title, job skills, employer, geographical location, and so on. Thus, the accuracy of the information that is known about the person may affect the ability of the application to perform its functions effectively.

### DESCRIPTION OF THE DRAWINGS

Some embodiments are illustrated by way of example and not limitation in the accompanying drawings, in which:

FIG. 1 is a block diagram of the functional modules or components that comprise a computer-network based social network service, including application server modules consistent with some embodiments of the invention;

FIG. 2 is a block diagram depicting some example modules of server application(s) 122 of FIG. 1;

FIG. 3 is a flow diagram illustrating an example method 300 of ranking multiple candidate standardized titles corresponding to a raw title;

FIG. 4 is a block diagram of an example flow 400 for ranking candidate titles; and

FIG. 5 is a block diagram of a machine in the form of a computing device within which a set of instructions for causing the machine to perform any one or more of the methodologies discussed herein may be executed.

### DETAILED DESCRIPTION

In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations permutations and combinations of the various features and elements described herein.

A social networking system may receive, store, and access a large amount of data, including user profile data, user behaviour data, and social network data, as described in more detail below. For example, if a member of a professional social network, such as LinkedIn, might create a profile and specify a current or past job position or title, such as “Patent Attorney” or “Partner at XYZ Associates,” as a long string, which may then be stored in a user profile database maintained by the social networking system. Members may also specify other information about themselves, such as company where they work, their geo-location, and the skills they possess. This information may then be mapped to canonical sets of job titles, companies, geo-locations, and skills respectively, for use by back-end applications of the social-networking system. For example, the canonical or “standardized” entities may be leveraged be applications for job recommendations, recruiter searching, advertising, news feed generation, and many other applications. Thus, the accuracy of the mapping of raw information entered by the user to canonical data items may be important.

Consistent with one aspect of the inventive subject matter, a method of ranking a set of candidate standardized titles selected from a corpus of standardized titles is disclosed. The set of candidate standardized titles are selected from the corpus of standardized titles as corresponding to a raw title. A combined inverse document frequency score is determined for each candidate standardized title in the set of candidate standardized titles. The combined inverse document frequency score is based on inverse frequency scores for each of a set of tokens derived from the set of candidate standardized titles. A ranking score is determined for each of the set of candidate standardized titles based on the combined inverse document frequency score. The ranking score for each of the set of candidate standardized titles is communicated for use by a separate module to improve an accuracy in a functionality of the separate module.

This method and other methods or embodiments disclosed herein may be implemented as a computer system having one or more modules (e.g., hardware modules or software modules). Such modules may be executed by one or more processors of the computer system. This method and other methods or embodiments disclosed herein may be embodied as instructions stored on a machine-readable medium that, when executed by one or more processors, cause the one or more processors to perform the instructions.

Other advantages and aspects of the present inventive subject matter will be readily apparent from the description of the figures that follows.

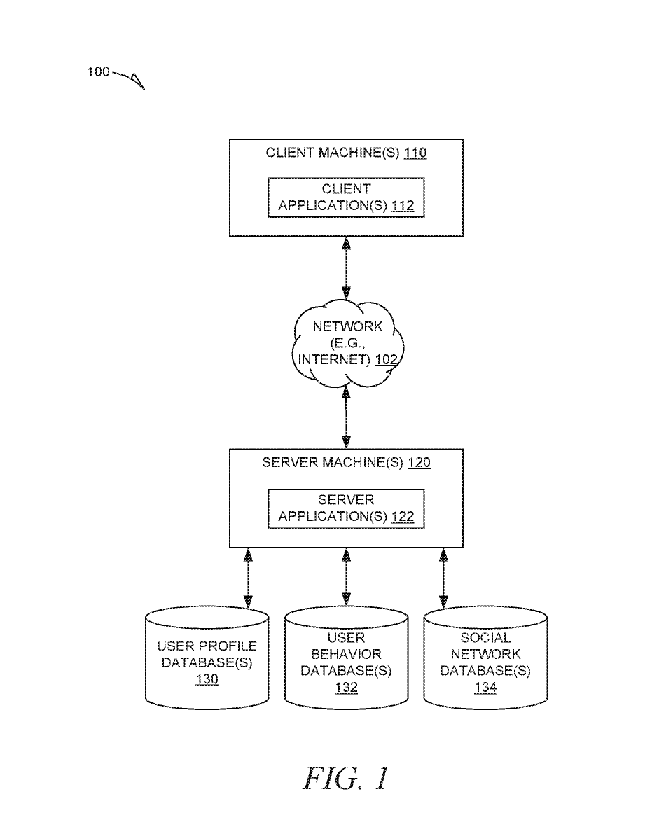

FIG. 1 is a network diagram depicting a system 100, within which various example embodiments may be deployed. The system 100 includes server machine(s) 120. Server application(s) 122 may provide server-side functionality (e.g., via a network 102) to one or more client application(s) 112 executing on one or more client machine(s) 110. Examples of client machine(s) 110 may include mobile devices, including wearable computing devices. A mobile device may be any device that is capable of being carried around. Examples of mobile devices include a laptop computer, a tablet computer (e.g., an iPad), a mobile or smart phone (e.g., an iPhone), and so on. A wearable computing device may be any computing device that may be worn. Examples of wearable computing devices include a smartwatch (e.g., a Pebble E-Paper Watch), an augmented reality head-mounted display (e.g., Google Glass), and so on. Such devices may use natural language recognition to support hands-free operation by a user.

In various embodiments, the server machine(s) 120 may implement a social networking system. The social networking system may allow users to build social networks by, for example, by declaring or acknowledging relationships and sharing ideas, pictures, posts, activities, events, or interests with people in their social networks. Examples of such social networks include LinkedIn and Facebook.

In various embodiments, the client application(s) may include a web browser (e.g., a browser, such as the Internet Explorer browser developed by Microsoft Corporation of Redmond, Wash.), a native application (e.g., an application supported by an operating system of the device, such as Android, Windows, or iOS), or other application. Each of the one or more clients may include a module (e.g., a plug-in, add-in, or macro) that adds a specific service or feature to a larger system. In various embodiments, the network 102 includes one or more of the Internet, a Wide Area Network (WAN), or a Local Area Network (LAN).

The server applications 122 may include an API server or a web server configured to provide programmatic and web interfaces, respectively, to one or more application servers. The application servers may host the one or more server application(s) 122. The application server may, in turn, be coupled to one or more data services and/or databases servers that facilitate access to one or more databases or NoSQL or non-relational data stores. Such databases or data stores may include user profile database(s) 130, user behavior database(s) 132, or social network database(s) 134. In various embodiments, the user profile database(s) 130 include information about users of the social networking system.

In various embodiments, the user profile database(s) 130 include information about a user maintained with respect to a social networking system implemented by the server application(s) 122 executing on the server machine(s) 120. For example, the user profile database(s) 130 may include data items pertaining to the user's name, employment history (e.g., titles, employers, and so on) educational background (e.g., universities attended, degrees attained, and so on), skills, expertise, endorsements, interests, and so on. This information may have been specified by the user or collected from information sources separate from the user.

The user behavior database(s) 132 may include information pertaining to behaviors of the user with respect to the social networking system. For example, the user behavior database(s) 132 may include data items pertaining to actions performed by the user with respect to the system. Examples of such actions may include accesses of the system by the user (e.g., log ins and log outs), postings made by the user, pages viewed by the user, endorsements made by the user, likings of postings of other users, messages sent to other users or received by the user, declarations of relationships between the user and other users (e.g., requests to connect to other users or become a follower of other users), acknowledgements of declarations of relationships specified by the other users (e.g., acceptance of a request to connect), endorsements made by the user, and so on.

The social network database(s) 134 may include information pertaining to social networks maintained with respect to the social networking system. For example, the social network database(s) 134 may include data items pertaining to relationships between users or other entities (e.g., corporations, schools, and so on) of the social networking system. For example, the data items may describe declared or acknowledged relationships between any combination of users or entities of the social networking system.

The server application(s) 122 may provide a number of functions and services to users who access the server machine(s) 120. While the server application(s) 122 are shown in FIG. 1 to be included on the server machine(s) 120, in alternative embodiments, the server application(s) 210 may form part of a service that is separate and distinct from the server machine(s) 120.

Further, while the system 100 shown in FIG. 1 employs a client-server architecture, various embodiments are, of course, not limited to such an architecture, and could equally well find application in a distributed, or peer-to-peer, architecture system, for example. The various applications could also be implemented as standalone software programs, which do not necessarily have computer networking capabilities. Additionally, although not shown in FIG. 1, it will be readily apparent to one skilled in the art that client machine(s) 110 and server machine(s) 120 may be coupled to multiple additional networked systems.

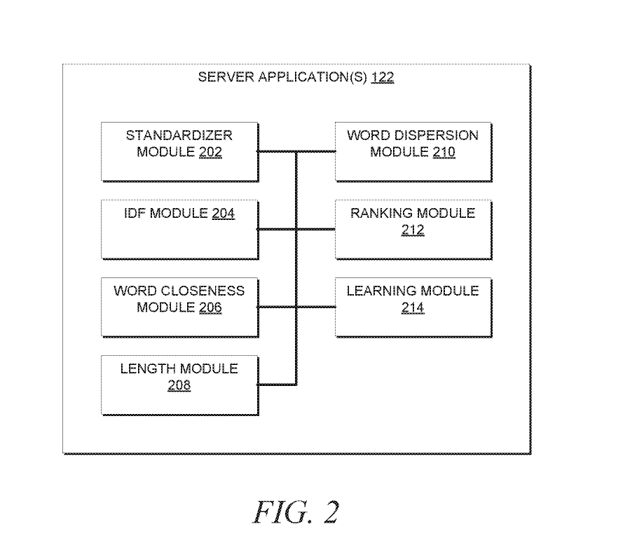

FIG. 2 is a block diagram depicting some example modules of server application(s) 122 of FIG. 1. In various embodiments, these modules implement a ranking algorithm for ranking candidate sets of titles as corresponding to a raw title, as described in more detail below. A standardizer module 202 may be configured to select a candidate set of standardized titles from a corpus of standardized titles. For example, of a set of thousands of corpus standardized titles, the standardizer module 202 may select a small subset (e.g., 2-5 titles) as corresponding to a raw title. The selection may be based on a simple matching algorithm (e.g., a keyword matching algorithm). An IDF module 204 may be configured to generate a combined inverse document frequency score for each of the set of candidate standardized titles, as described in more detail below. A word closeness module 206 may be configured to generate a word closeness score for each of the set of candidate standardized titles, as described in more detail below. A length module 208 may be configured to generate a length score for each of the set of candidate standardized titles, as described in more detail below. A word dispersion module 210 may be configured to generate a word dispersion score for each of the candidate standardized titles, as described in more detail below. A ranking module 212 may be configured to generate a ranking score for each of the candidate standardized titles, as described in more detail below. A learning module 214 may be configured to apply computer learning techniques to adjust the ranking algorithm (e.g., by changing weights assigned to a combination of scores used to generate the ranking scores), as described in more detail below.

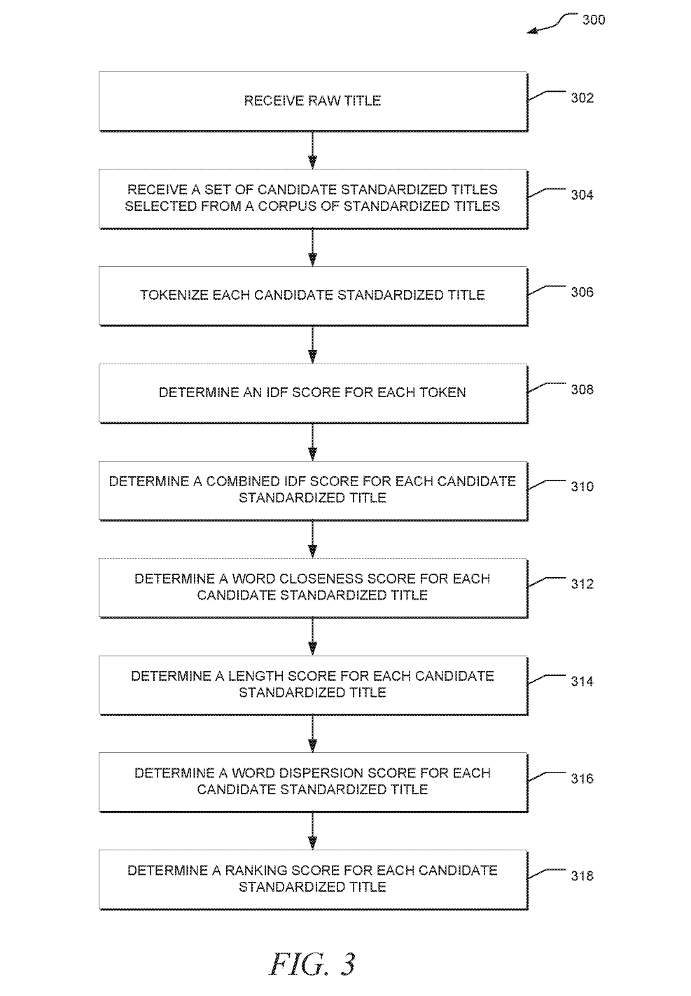

FIG. 3 is a flow diagram illustrating an example method 300 of ranking multiple candidate standardized titles corresponding to a raw title. In various embodiments, the method 300 may be implemented by one or more of the modules of FIG. 2.

At operation 302, a free-form (or raw) title is received. For example, this raw title may be the title specified in free-form by a member of a social networking system for inclusion on the member's profile or a title specified in free-form by a job recruiter for inclusion in a job posting.

At operation 304, a set of candidate standardized titles corresponding to the raw title is selected from a corpus of standardized titles. In example embodiments, the selection is performed by a separate module (e.g., the standardizer module) based on a separate matching algorithm (e.g., a keyword matching algorithm). If the returned set is a singleton, the single title is returned and no further processing is needed. For example, for a raw title such as “Sr. Software Eng.” the one and only match returned by the standardizer module may be “Senior Software Engineer.” In this case, no further processing is needed.

At operation 306, each of the candidate standardized titles is tokenized. For example, for a set of two selected standardized titles, including “Senior Controller” and “Site Controller,” three tokens may be identified: “senior,” “site,” and “controller.”

At operation 308, for each of the identified tokens, an inverse document frequency (idf) is determined. The idf is the frequency of the token in the corpus of standardized titles. For example, for the above example, each of the idf for each of the tokens “senior,” “site,” and “controller” is determined. For example, the idf for the token “senior” may be determined to be 2.27E-4, the idf for the token “site” may be determined to be 0.009, and the idf for the token “controller” may be determined to be 0.004.

At operation 310, a combined idf score is calculated for each identified candidate standardized title. In example embodiments, for each identified candidate standardized title, the combined idf score may be calculated by multiplying the idf for each of the tokens of the identified candidate standardized title. Other combination techniques may also be used, including addition. For example, multiplying the idf of each of the tokens for the first candidate standardized title (e.g., “Senior Controller”) may yield a first combined idf score (e.g., 0.004878590582373817) and multiplying the idf of each of the tokens for the second candidate standardized (e.g., “Site Controller”) may yield a second combined idf score (e.g., 0.013996957183221038). In this example, the combined idf score for “Site Controller” is greater than the combined idf score for “Senior Controller” because the token “Senior” has a greater frequency in the corpus than the token “Site.” In example embodiments, it is assumed that rarer tokens (e.g., tokens that appear less frequently in the corpus) are more specific than less rare tokens. In other words, standardized title having more rare tokens have a more specific meaning and will therefore, by being less generic, be closer to the intended meaning of the raw title.

At operation 312, a word closeness score for each of the candidate standardized title is determined. The idea is that if two words within a candidate standardized title occur more frequently together than each of them occur independently, then they likely form a unit (e.g., a phrase or other relationship relevant to the closeness of the words). In other words, a statistical and language agnostic technique may be used to arrive at the linguistic notion of a phrase. Thus, language specific rules or expertise need not be leveraged to uncover phrases such as “software engineer” for each language, which might cost-prohibitive and not scalable (e.g., trained linguists would have to be utilized for each language).

In various embodiments, the technique used to measure closeness of words within a candidate standardized title may be pointwise mutual information (PMI). The PIM of a pair of outcomes x and y belonging to discrete random variables X and Y quantifies the discrepancy between the probability of their coincidence given their joint distribution and their individual distribution. Mathematically, PMI is log(p(x,y)/(p(x)*p(y)). The mutual information (MI) of the random variables X and Y is the expected value of the PMI over all possible outcomes (with respect to the joint distribution p(x,y)). In other words, the greater the value is for two words, the more correlated the two words are. In the above example, “software” and “programmer” may appear together more frequently than “staff” and “programmer” in the corpus of standardized titles. For example, “staff” may be distributed across many titles, including “doctor” and “nurse,” whereas “software” may be more restricted in its distribution. In example embodiments, candidate standardized titles that include two or more words may be ranked based on their correlation scores. The closeness score for each candidate standardized title may be equal to or based on the PMI scores for each bigram (e.g., a two-word contiguous sentence) included in the candidate standardized title. For example, if the PMI for “staff programmer” is 0.8664425302901407 and the PMI for “software programmer” is 1.5920519869947474, it may suggest that “software programmer” represents the core meaning of “staff software programmer” better than “staff programmer.” Thus, the correlation score for the candidate standardized title “Software Programmer” may be assigned a higher value than the value assigned to the correlation score for the candidate standardized title “Staff Programmer.”

At operation 314, a length score is calculated for each of the candidate standardized titles. In example embodiments, a candidate standardized title having two words may considered to be less informative than a candidate standardized title having three words. Thus, the length score for the candidate standardized title having three words may be given a higher score than the length score for the candidate standardized title having two words.

At operation 316, a word dispersion score is calculated for each of the candidate standardized titles. In example embodiments, it may be assumed that, if a standardized title contains two words that are close to one another and the same two words were far from one another in the raw title, then the standardized title probably cannot be mapped to the raw title with high confidence. Thus, in example embodiments, the dispersion scores determined for each standardized title represent how many non-adjacent bigrams the standardized title has in comparison to the raw title and includes a penalty for non-adjacency. In example embodiments, the dispersion score is computed as a ratio of the number of words in a standardized title divided by the number of words that separate these words in raw title.

In example embodiments, the smaller the dispersion ratio of the standardized title, the less confidence we have in this standardized title accurately reflecting the meaning of the original raw title. For example, if we have a two word title and the two words are five words apart in the original title, the dispersion ratio is 2/5. Conversely, if we have two words in the standardized title that are only one word apart in the original title, then dispersion ratio is 2/3. For example, if the raw title was “director of social media with travel,” and the candidate standardized titles were “travel director,” “social director,” “media director,” and “social media director,” the dispersion scores for each of the candidate standardized titles may be the following: {0.0073392531851.610085=[travel director], 6.588351677833811=[director social media], 0.007963157720387077=[media director], and −0.033273808265894156=[social director]}. In example embodiments, negative scores may appear when words in a candidate standardized title are inverted with respect to the order of the words given in a raw title.

At operation 318, a ranking score for each candidate standardized title is calculated. In various embodiments, the ranking score may be based on a combination of one or more of the idf score, word closeness score, length score, or word dispersion score. For example, one of the scores may be used or two or more of the scores may be combined (e.g., multiplied or added) together to determine the ranking score.

In various embodiments, a primary score may be selected as the ranking score and additional scores combined into the primary score as necessary to break ties in the ranking score. For example, the combined idf score may be selected as the primary score. However, if the combined idf scores associated with the standardized titles are not be sufficient to determine a ranking for the candidate standardized titles, an additional score may be combined into the combined idf scores. For example, for the raw title “Staff Software Programmer,” two candidate standardized titles may be identified: “Staff Programmer” and “Software Programmer.” However, both of the candidate standardized titles may be determined to have a combined idf score of 0.008. In this case, an additional score, such as the word closeness score, may be selected as a secondary score to break the tie in the ranking between the two candidate standardized titles.

In example embodiments, the ranking scores for each of the standardized titles may be communicated to a separate module, such as a module of an advertisement, content selection, or other of the application(s) 122, for processing. In example embodiments, based on the separate module only taking one standardized title as an input, only the top ranking score may be communicated to the separate module for processing. Thus, for example, advertising and content selected by the social network system for presentation to a user may be based on a more accurate assessment of raw the job title specified by the user in the profile of the user.

Although the above method provides an example of an ordered sequence in which the various scores may be calculated, it is contemplated that the scores may be calculated in any order. Furthermore, it is contemplated than any number of the scores may be used in calculating the ranking score for a candidate standardized title, singly or in combination.

In example embodiments, a weight may be assigned to each score that is used in combination to determine the ranking score for each standardized title. The weights may then be adjusted based on computer learning. For example, input from an administrator or from a crowd-sourcing tool may be used to change the weightings and thus improve the accuracy of the ranking scores over time.

Although job titles are used as an example, it is contemplated that the example method 300 may be used to determine rankings of candidate items in any data set having standardized values with respect to any raw data item. Examples of data sets having standardized values may include, in addition to job titles, names of employers, corporations, schools, associations, societies, and so on; geographical locations, including names of countries, states, cities, towns, and so on; job fields; job skills, such as job skills pertaining to one or more job fields; names of activities related to a school, such as extracurricular or intramural activities; names of interest or hobbies; and so on.

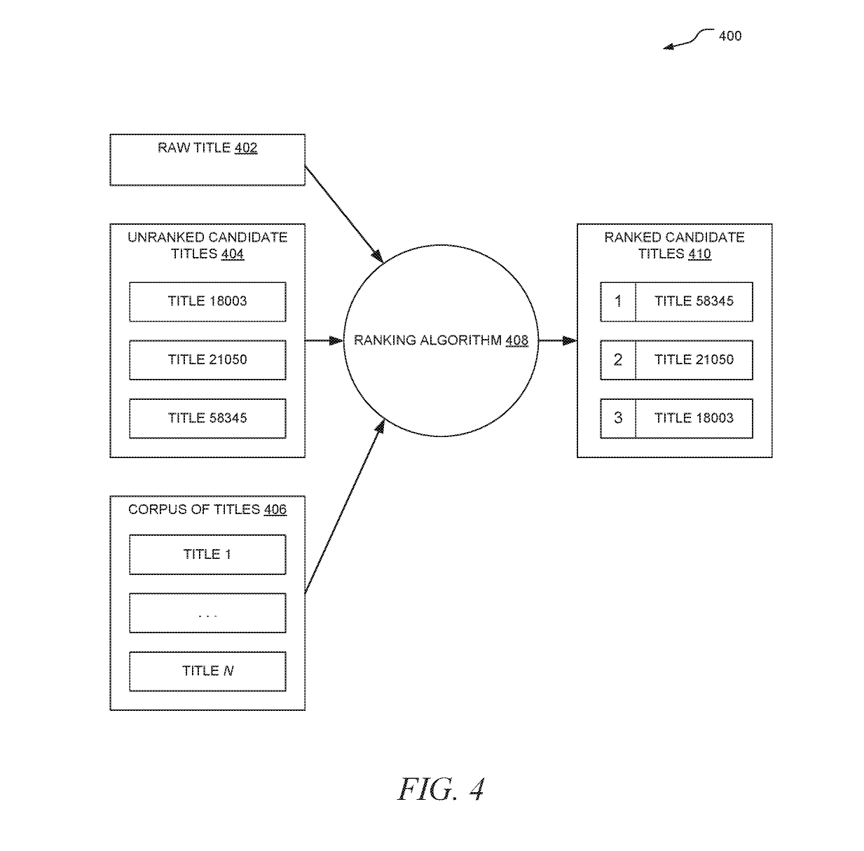

FIG. 4 is a block diagram of an example flow 400 for ranking candidate titles. A reference to a raw title 402, a reference to a set of unranked candidate titles 404, and a reference to a corpus of titles 406 are provided as inputs to a ranking algorithm 408. Titles 18003, 21050, and 58345 are provided as examples of unranked candidate titles that may be selected from the corpus of titles 406 based on a preliminary matching analysis (e.g., a keyword matching analysis). The ranking algorithm 408 then ranks the unranked candidate titles 404 (e.g., using a ranking technique, such as the technique disclosed in example method 300). The ranking algorithm 408 then provides ranked candidate titles 410 as output. In example embodiments, each of the ranked candidate titles may be associated with a ranking (e.g., 1, 2, 3, and so on), as depicted. Although not shown, each of the ranked candidate titles may associated with a ranking score (e.g., such as the ranking score of method 300) alternatively to or in addition to the ranking. Various server application(s) 122, such as an advertisement application or news feed application may use the ranked candidate titles 410 to more accurately target a member of the social networking system (e.g., for advertising or content). In various embodiments, the ranking algorithm 408 may simply output the top-ranked candidate title (e.g., for applications that are configured to act based only on a single candidate title).

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

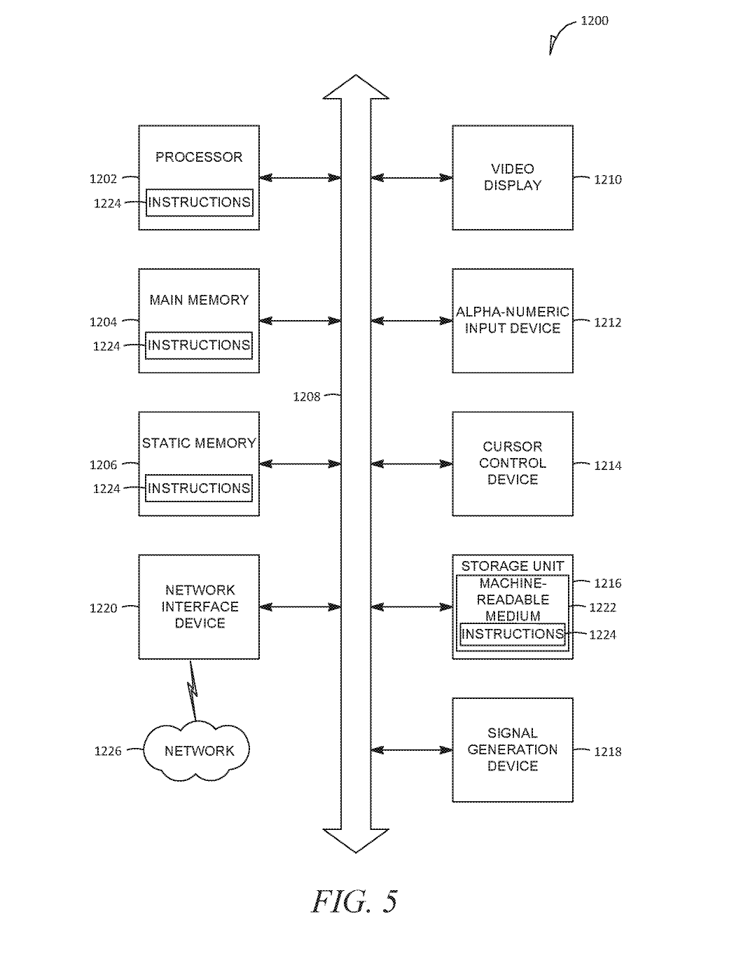

FIG. 5 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A system comprising:
one or more processors;
means for enabling a separate system to assess one or more strengths of correspondences between a raw title and a set of candidate standardized titles for targeting of content that is to be presented to a user of the separate system, the set of candidate standardized titles being a subset of a corpus of standardized titles that is selected based on an application of a matching algorithm comparing the raw title to the corpus of standardized titles, the enabling including:
receiving the raw title and the set of candidate standardized titles;
deriving a set of tokens from the selected set of candidate standardized titles, the set of tokens being a set of unique keywords included in the selected set of candidate standardized titles;
calculating one or more inverse frequency scores for each of the set of tokens relative to the corpus of standardized titles;
determining one or more combined inverse document frequency scores for the set of candidate standardized titles, each of the one or more combined inverse document frequency score based on a combination of the one or more inverse frequency scores calculated for each of the set of tokens relative to the corpus of standardized titles;
determining one or more ranking scores for each of the set of candidate standardized titles based on the combined inverse document frequency score; and
means for communicating the one or more ranking scores for each of the set of candidate standardized titles to the separate system, the separate system configured to perform the assessment based on the one or more ranking scores.

2. The system of claim 1, wherein the set of candidate standardized titles is selected from the corpus of standardized titles based on an application of a keyword matching algorithm to each of the standardized titles in the corpus and the raw title.

3. The system of claim 1, further comprising means for determining a word closeness score for each of the set of candidate standardized titles and wherein the determining of the ranking score is further based on the word closeness score.

4. The system of claim 1, further comprising means for determining a length score for each of the set of candidate standardized titles and wherein the determining of the ranking score is further based on the length score.

5. The system of claim 1, further comprising means for determining a word dispersion score for each of the set of candidate standardized titles and wherein the determining of the ranking score is further based on the word dispersion score.

6. The system of claim 3, wherein a first weighting is assigned to the inverse document frequency score and a second weighting is assigned to the word closeness score and the method further comprises means for adjusting the first weighting and the second weighting over time based on inputs pertaining to the accuracy of the ranking score.

7. The system of claim 3, wherein the word closeness score is based on an application of a pointwise mutual information calculation to the corpus and each of the candidate standardized titles.

8. A method comprising:
enabling a separate system to assess one or more strengths of correspondences between a raw title and a set of candidate standardized titles for targeting of content that is to be presented to a user of the separate system, the set of candidate standardized titles being a subset of a corpus of standardized titles that is selected based on an application of a matching algorithm comparing the raw title to the corpus of standardized titles, the enabling including
receiving the raw title and the set of candidate standardized titles;
deriving a set of tokens from the selected set of candidate standardized titles, the set of tokens being a set of unique keywords included in the selected set of candidate standardized titles;
calculating one or more inverse frequency scores for each of the set of tokens relative to the corpus of standardized titles;
determining one or more combined inverse document frequency scores for the set of candidate standardized titles, each of the one or more combined inverse document frequency score based on a combination of the one or more inverse frequency scores calculated for each of the set of tokens relative to the corpus of standardized titles;
determining one or more ranking scores for each of the set of candidate standardized titles based on the combined inverse document frequency score; and
communicating the one or more ranking scores for each of the set of candidate standardized titles to the separate system, the separate system configured to perform the assessment based on the one or more ranking scores.

9. The method of claim 8, wherein the set of candidate standardized titles is selected from the corpus of standardized titles based on an application of a keyword matching algorithm to each of the standardized titles in the corpus and the raw title.

10. The method of claim 8, wherein the one or more modules are further configured to determine a word closeness score for each of the set of candidate standardized titles and the determining of the ranking score is further based on the word closeness score.

11. The method of claim 8, wherein the one or more modules are further configured to determine a length score for each of the set of candidate standardized titles and the determining of the ranking score is further based on the length score.

12. The method of claim 8, wherein the one or more modules are further configured to determine a word dispersion score for each of the set of candidate standardized titles and the determining of the ranking score is further based on the word dispersion score.

13. The method of claim 10, wherein a first weighting is assigned to the inverse document frequency score and a second weighting is assigned to the word closeness score and the one or more modules are further configured to adjust the first weighting and the second weighting over time based on inputs pertaining to the accuracy of the ranking score.

14. The method of claim 10, wherein the word closeness score is based on an application of a pointwise mutual information calculation to the corpus and each of the candidate standardized titles.

15. A non-transitory computer-readable storage medium storing instructions thereon, which, when executed by one or more processors, cause the one or more processors to perform operations, the operations comprising:
enabling a separate system to assess one or more strengths of correspondences between a raw title and a set of candidate standardized titles for targeting of content that is to be presented to a user of the separate system, the set of candidate standardized titles being a subset of a corpus of standardized titles that is selected based on an application of a matching algorithm comparing the raw title to the corpus of standardized titles, the enabling including
receiving the raw title and the set of candidate standardized titles;
deriving a set of tokens from the selected set of candidate standardized titles, the set of tokens being a set of unique keywords included in the selected set of candidate standardized titles;
calculating one or more inverse frequency scores for each of the set of tokens relative to the corpus of standardized titles;
determining one or more combined inverse document frequency scores for the set of candidate standardized titles, each of the one or more combined inverse document frequency score based on a combination of the one or more inverse frequency scores calculated for each of the set of tokens relative to the corpus of standardized titles;
determining one or more ranking scores for each of the set of candidate standardized titles based on the combined inverse document frequency score; and
communicating the one or more ranking scores for each of the set of candidate standardized titles to the separate system, the separate system configured to perform the assessment based on the one or more ranking scores.

16. The non-transitory computer-readable storage medium of claim 15, wherein the set of candidate standardized titles is selected from the corpus of standardized titles based on an application of a keyword matching algorithm to each of the standardized titles in the corpus and the raw title.

17. The non-transitory computer-readable storage medium of claim 15, wherein the one or more modules are further configured to determine a word closeness score for each of the set of candidate standardized titles and the determining of the ranking score is further based on the word closeness score.

18. The non-transitory computer-readable storage medium of claim 15, wherein the one or more modules are further configured to determine a length score for each of the set of candidate standardized titles and the determining of the ranking score is further based on the length score.

19. The non-transitory computer-readable storage medium of claim 15, wherein the one or more modules are further configured to determine a word dispersion score for each of the set of candidate standardized titles and the determining of the ranking score is further based on the word dispersion score.

20. The non-transitory computer-readable storage medium of claim 17, wherein a first weighting is assigned to the inverse document frequency score and a second weighting is assigned to the word closeness score and the one or more modules are further configured to adjust the first weighting and the second weighting over time based on inputs pertaining to the accuracy of the ranking score.
